(19) United States
(12) Patent Application Publication
(10) Pub. No.: US 2008/0189593 A1
(43) Pub. Date: Aug. 7, 2008

(54) System and method for enabling flash playback of MP3 files available on a web page

(76) Inventors: Tim Baker, Alisa Craig (CA); Dan Kantor, New York, NY (US)

Correspondence Address: YAHOO! INC.;C/O DREIER LLP, 499 PARK AVENUE, NEW YORK, NY, 10022, US

(21) Appl. No.: 11/602,450

(22) Filed: Nov. 20, 2006

(51) Int. Cl. G06F 17/00; G06F 15/16; G06F 3/048

(52) U.S. Cl. 715/207; 715/205; 715/764; 709/203; 709/217

(57) ABSTRACT

A method comprises using a browser to navigate to a web address; downloading from the web address web page data including an MP3 file link to an MP3 file; downloading a playtagger script; using the playtagger script to generate a playback icon next to the MP3 file link; downloading a Flash handler; and using the Flash handler to configure a Flash plugin to playback the MP3 file in response to activation of the playback icon.

### TECHNICAL FIELD

This invention relates generally to web sites, and more particularly provides a system and method for enabling Flash playback of MP3 files available on a web page.

### BACKGROUND

Many websites provide music for visitors in the form of links to MP3 files. Traditionally, clicking on such a link launches an external player, such as Windows Media Player, Real Player or QuickTime. The launching of an external player is a time-consuming process that redirects the visitor's attention away from the web page. What is needed is a simple mechanism to enable playback of MP3 files without having to launch an external player.

### SUMMARY

A playtagger script allows playback of MP3 files (and/or other files of other file types) directly on a website or blog. The playtagger script need not preload the MP3 files, thus making a web page load more quickly. External MP3 players need not be launched, thereby maintaining user attention to the web page. In addition, the playtagger script may provide visitors with the opportunity to tag and post the MP3 link to del.icio.us.

According to one embodiment, the present invention provides a system, comprising web page data including an MP3 file link to an MP3 file; a playtagger script for generating a playback icon next to the MP3 file link; and a Flash handler for configuring a Flash plugin to playback the MP3 file in response to activation of the playback icon.

The playtagger script may include JavaScript. The playtagger script may be located on one or more websites available to a browser. The web page data may include a playtagger reference for enabling the browser to fetch the playtagger script. The playtagger script may be further operative to replace the playback icon with at least a stop icon, in response to the activation. The Flash handler may be further operative to cause the Flash plugin to stop the playback in response to a stop request. The playtagger script may be further operative to replace the playback icon with a stop/pause/tag icon set, in response to the activation. The Flash handler may be further operative to cause the Flash plugin to stop the playback in response to a stop request and to pause the playback in response to a pause request. The Flash handler may be located on one or more websites connected to a browser. The playtagger script may include a Flash handler function caller for enabling the browser to fetch the Flash handler. The MP3 file may include audio and/or video.

According to another embodiment, the present invention provides a method, comprising using a browser to navigate to a web address; downloading from the web address web page data including an MP3 file link to an MP3 file; downloading a playtagger script; using the playtagger script to generate a playback icon next to the MP3 file link; downloading a Flash handler; and using the Flash handler to configure a Flash plugin to playback the MP3 file in response to activation of the playback icon.

The playtagger script may include JavaScript. The playtagger script may be maintained on one or more websites available to the browser. The web page data may include a playtagger reference for enabling the browser to download the playtagger script. The method may further comprise using the playtagger script to replace the playback icon with at least a stop icon, in response to the activation. The method may further comprise using the Flash handler to cause the Flash plugin to stop the playback in response to a stop request. The method may further comprise using the playtagger script to replace the playback icon with a stop/pause/tag icon set, in response to the activation. The method may further comprise using the Flash handler to cause the Flash plugin to stop the playback in response to a stop request and to pause the playback in response to a pause request. The Flash handler may be located on one or more websites connected to the browser. The playtagger script may include a Flash handler function caller for enabling the browser to download the Flash handler. The MP3 file may include audio and/or video.

According to yet another embodiment, the present invention provides a system, comprising means for navigating to a web address; means for downloading from the web address web page data including an MP3 file link to an MP3 file; scripting means for generating a playback icon next to the MP3 file link; and Flash handler means for configuring a Flash plugin to playback the MP3 file in response to activation of the playback icon.

### BRIEF DESCRIPTION OF THE DRAWINGS

FIG. 1 is a block diagram of a network system for enabling Flash playback of an MP3 file, in accordance with an embodiment of the present invention.

FIG. 2 is a block diagram illustrating details of the playtagger script of FIG. 1, in accordance with an embodiment of the present invention.

FIG. 3 is a block diagram illustrating details of a computer system.

FIG. 4 is flowchart illustrating an example method of enabling Flash playback of an MP3 audio file, in accordance with an embodiment of the present invention.

FIG. 5 illustrates an example user interface with three MP3 file links and three playback icons, in accordance with an embodiment of the present invention.

FIG. 6 illustrates an example user interface with three MP3 file links, two playback icons and one stop/pause/tag icon set, in accordance with an embodiment of the present invention.

FIG. 7 illustrates an example user interface with three MP3 file links, two playback icons and one stop/resume/tag icon set, in accordance with an embodiment of the present invention.

FIG. 8 illustrates an example user interface for tagging an MP3 file link at the Del.icio.us website, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

A playtagger script allows playback of MP3 files (and/or other files of other file types) directly on a website or blog. Using Flash, the playtagger script need not preload the MP3 files, thus making a web page load more quickly. External MP3 players need not be launched, thereby maintaining user attention to the web page. In addition, the playtagger script may provide visitors with the opportunity to tag and post the MP3 link to del.icio.us.

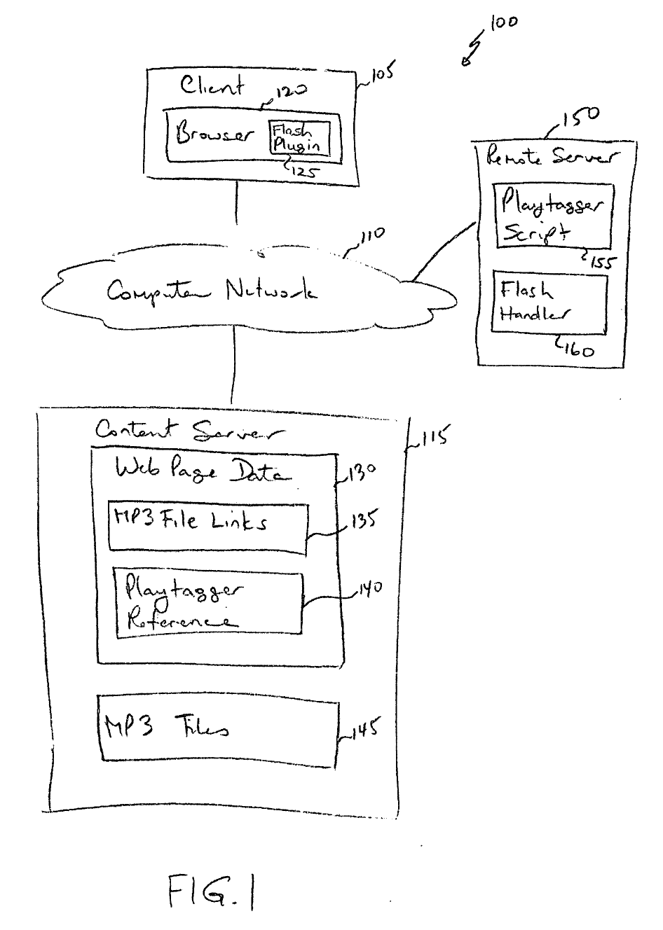

FIG. 1 is a block diagram of a network system 100 for enabling Flash playback of an MP3 file, in accordance with an embodiment of the present invention. Network system 100 includes a client 105, a content server 115 and a remote server 150, each coupled to a computer network 1 10.

The client 105 includes a browser 120 with a Flash plugin 125. The browser 120 may be high-profile browser such as Microsoft Internet Explorer or Netscape Navigator. The browser 120 enables the user of the client 105 to navigate to web pages, including web pages managed by the content server 115. As will be described in greater detail below, the Flash plugin 125 may be configured to playback a Flash file (audio and/or video).

The content server 115 includes web page data 130 with MP3 file links 135 to MP3 files 145. Although shown as located on the content server 115, the MP3 files 145 may be located on any server coupled to the computer network 110. The web page data 130 also includes a playtagger reference 140 that directs the browser 120 to download a playtagger script that may be located on any server available to the browser 120, e.g., any server coupled to the computer network 110 (e.g., see playtagger script 155 of remote server 150, described below).

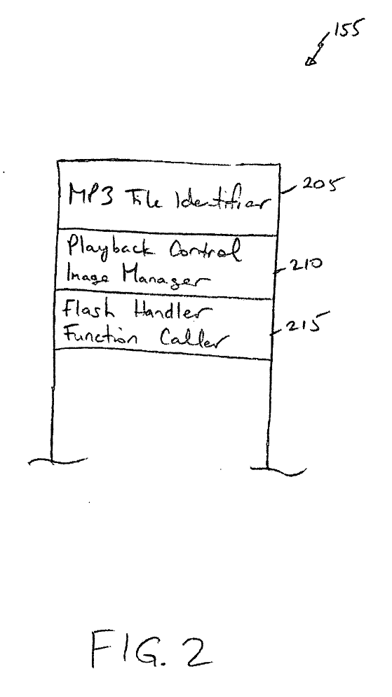

The remote server 150 includes a playtagger script 155 that may be addressed by the playtagger reference 140 located in the web page data 130. The playtagger script 155 is configured to identify all MP3 file links 135 in the web page data 130, to generate a playback icon (e.g., a standard playback triangle) adjacent to each of the MP3 file links 135, to generate a stop icon adjacent to each of the MP3 files links 135 during playback, and to enable Flash playback and stopping of the MP3 file 145. For example, the playtagger script 155 may cause playback of an MP3 file 145 upon detecting a mouse-down event over a playback icon. The playtagger script 155 may cause stopping of the playback of the MP3 file 145 upon detecting a mouse-down event over a stop icon. Additional details of the playtagger script 155 are shown and described with reference to FIG. 2.

The remote server 150 also includes a Flash handler 160. Although the Flash handler 160 in this embodiment is located on the same server 150, the Flash handler 160 can be located on any server available to the browser 120, e.g., any server coupled to the computer network 110. The Flash handler 160 communicates with the Flash plugin 125 to effect the playback and stopping of the MP3 file 145, in response to a function call from the playtagger script 155. In one embodiment, the playtagger script 155 downloads the Flash handler 160 (e.g., as a Flash movie), and inserts parameters (e.g., the URL of the MP3 file 145) into the Flash handler 160. The Flash handler 160 automatically starts playing the MP3 file 145, indicating playback status such as loading, playing, paused, and finished.

FIG. 2 is a block diagram illustrating details of the playtagger script 155, in accordance with an embodiment of the present invention. The playtagger script 155 includes an MP3 file identifier 205, a playback control image manager 210, and a Flash handler function caller 215. The MP3 file identifier 205 browses the web page data, e.g., HTML code, to identify all anchor elements that link to a file with an MP3 extension. The playback control image manager 210 places a playback icon adjacent to each MP3 filename and provides functionality to the playback icon that, upon detecting a mouse-down event over the playback icon, the Flash handler function caller 215 causes the Flash handler 160 to initiate playback of the associated MP3 file 145. During playback, the playback control image manager 210 places a stop icon (e.g., a standard stop square) adjacent to the MP3 filename presented to the user and provides functionality to the stop icon that, upon detecting a mouse-down event over the stop icon, the Flash handler function caller 215 causes the Flash handler 160 to stop playback of the associated MP3 file 145. During playback, the playback control image manager 210 may also provide additional icons and functionality to enable pausing and restarting playback (via the Flash handler function caller 215 and the Flash handler 160), to tag the MP3 link to Del.icio.us, etc.

The Flash handler function caller 215 includes code, e.g., JavaScript, to launch the Flash handler 160, e.g., an Adobe (Macromedia) Flash file, to configure the Flash plugin 125 to playback the associated MP3 file 145. The Flash handler function caller 215 also includes code, e.g., JavaScript, to launch the Flash handler 160, e.g., the Adobe (Macromedia) Flash file, to configure the Flash plugin 125 to stop playback of the associated MP3 file 145. The Flash handler function caller 215 and Flash handler 160 may also include code to enable additional functionality including to pause and restart playback, etc.

In one embodiment, the web page developer need only add to the web page a playtagger reference 140 to the playtagger script 155, e.g., <script type=“text/javascript” src=“http://del.icio.us/js/playtagger”></script> to the <head> section of the page.tpl.php file. In another embodiment, the web page developer may add the playtagger script 155 and Flash handler 160 directly to the web page. An example playtagger script 155 is as follows:

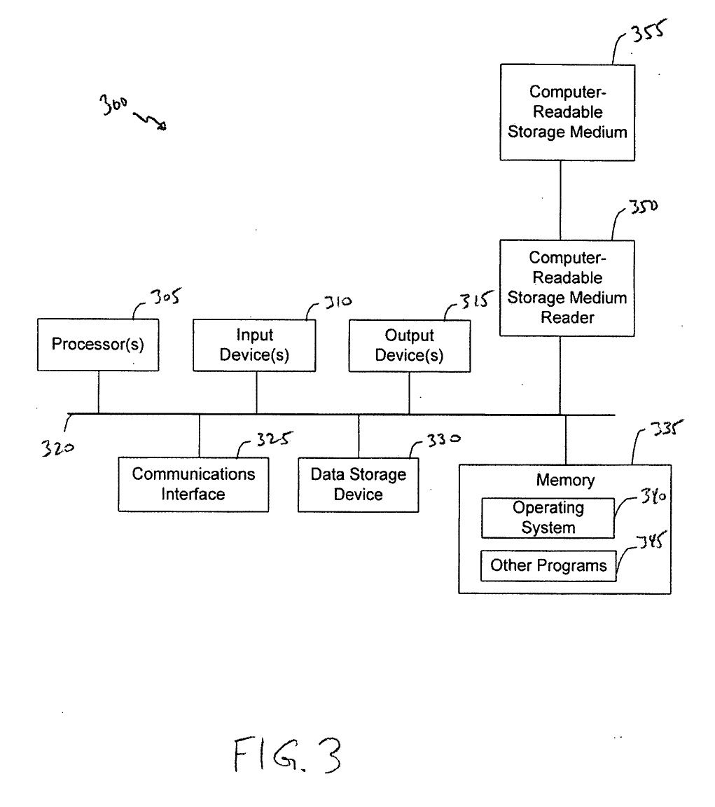

FIG. 3 is a block diagram illustrating details of a computer system 300, of which each of the client 105, the content server 115 or the remote server 150 may be an instance. Computer system 300 includes a processor 305, such as an Intel Pentium® microprocessor or a Motorola Power PC® microprocessor, coupled to a communications channel 320. The computer system 300 further includes an input device 310 such as a keyboard or mouse, an output device 315 such as a cathode ray tube display, a communications device 325, a data storage device 330 such as a magnetic disk, and memory 335 such as Random-Access Memory (RAM), each coupled to the communications channel 320. The communications interface 325 may be coupled to a network such as the wide-area network commonly referred to as the Internet. One skilled in the art will recognize that, although the data storage device 330 and memory 335 are illustrated as different units, the data storage device 330 and memory 335 can be parts of the same unit, distributed units, virtual memory, etc.

The data storage device 330 and/or memory 335 may store an operating system 340 such as the Microsoft Windows XP, Linux, the IBM OS/2 operating system, the MAC OS, or UNIX operating system and/or other programs 345. It will be appreciated that a preferred embodiment may also be implemented on platforms and operating systems other than those mentioned. An embodiment may be written using JAVA, C, JavaScript, and/or C++ language, or other programming languages, possibly using object oriented programming methodology.

One skilled in the art will recognize that the computer system 300 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 350 such as a magnetic disk drive, hard disk drive, magneto-optical reader, CPU, etc. may be coupled to the communications bus 320 for reading a computer-readable storage medium (CRSM) 355 such as a magnetic disk, a hard disk, a magneto-optical disk, RAM, etc. Accordingly, the computer system 300 may receive programs and/or data via the CRSM reader 350. Further, it will be appreciated that the term “memory” herein is intended to cover all data storage media whether permanent or temporary.

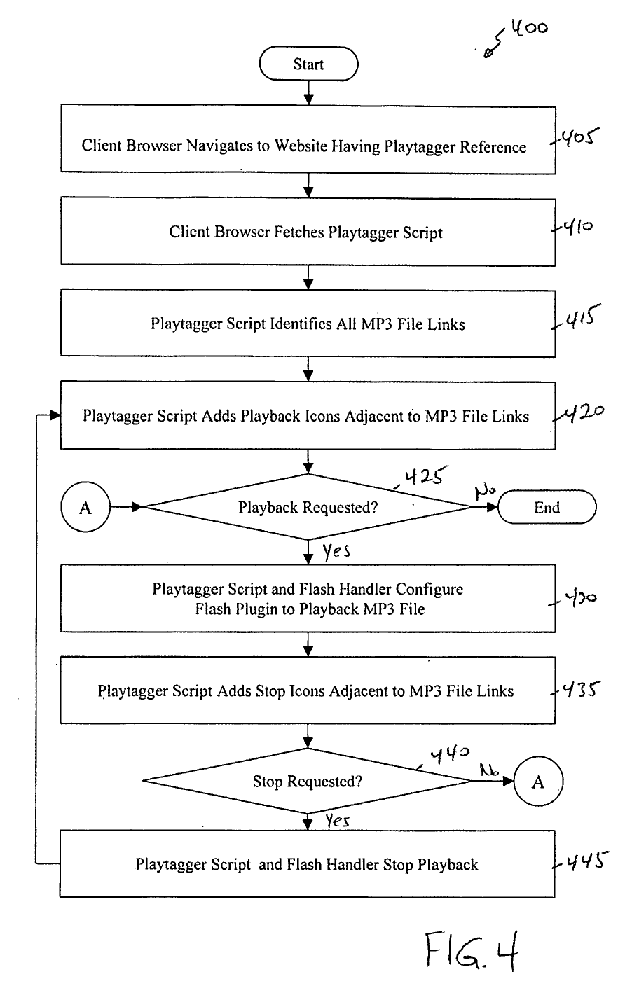

FIG. 4 is flowchart illustrating an example method 400 of enabling Flash playback of an MP3 audio file, in accordance with an embodiment of the present invention. Method 400 begins with the browser 120 on the client 105 in step 405 navigating to a website having a playtagger reference 140 therein. In response to the playtagger reference 140, the browser 120 on the client 105 in step 410 fetches the playtagger script 155. The playtagger script 155 in step 415 identifies all MP3 file links 135 in the web page, and in step 420 adds playback icons adjacent to the MP3 file links 135. The playtagger script 155 in step 425 determines whether playback of an MP3 file 145 is requested, possibly by awaiting a mouse-down event over one of the playback icons. If a playback request is not received, then method 400 ends. If a playback request is received, then the playtagger script 155 and Flash handler 160 in step 430 configure the Flash plugin 125, e.g., download a Flash movie file with the MP3 file link 135 associated with the playback icon as a parameter, to playback the MP3 file 145. The playtagger script 155 in step 435 replaces the playback icon with a stop icon and in step 440 determines if a stop request is received. If a stop request is not received, then the Flash plugin 125 continues playing the MP3 file 145, and upon completing playback returns to step 425 to determine if another MP3 file 145 is selected for playback. If a stop request is received, then the playtagger script 155 and Flash handler 160 in step 445 instruct the Flash plugin 125 to stop playback of the MP3 file 145. Method 400 then returns to step 420 to add the playback icons and thus to re-enable the playback functionality.

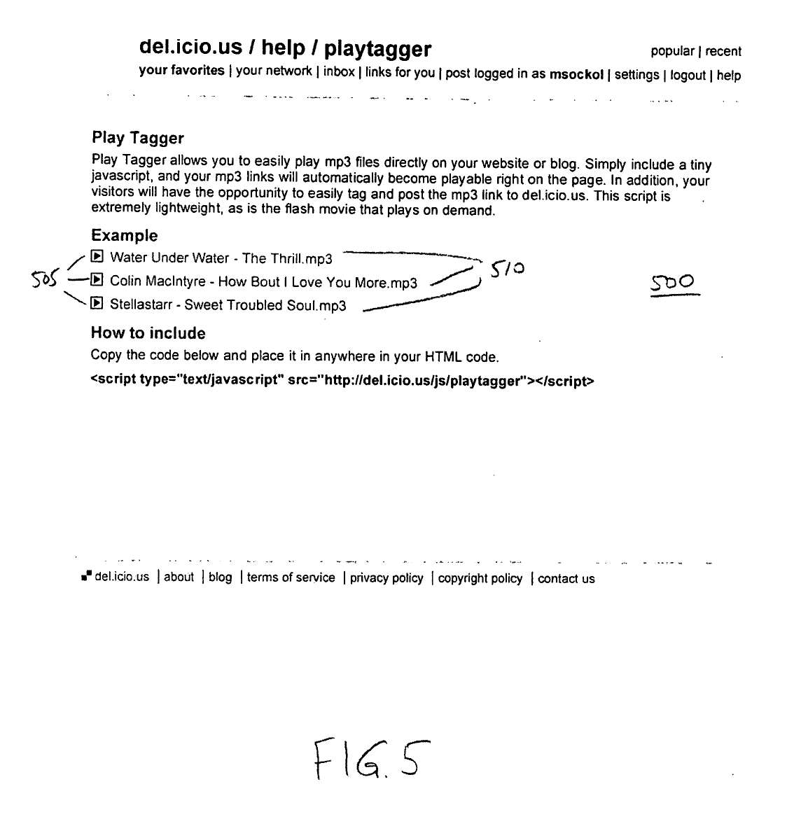

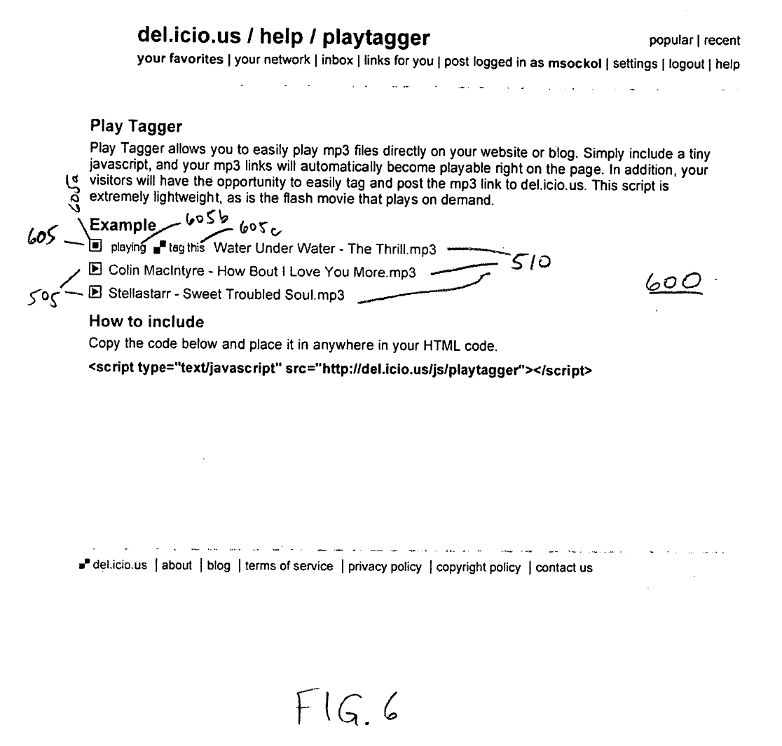

FIG. 5 illustrates an example user interface 500 with three MP3 file links 510 and three playback icons 505, in accordance with an embodiment of the present invention. The three playback icons 505 were generated automatically by the playtagger script 155, after-locating the three MP3 file links 510. Clicking on one of the MP3 file links 510 will cause an external player to launch, which will begin playing the associated MP3 file 145. However, clicking on one of the playback icons 505 will cause the playtagger script 155 and Flash handler 160 to begin playback of the MP3 file 145 using the Flash plugin 125, thus not taking the user's attention away from the website. FIG. 6 illustrates the user interface 500 after clicking the first playback icon 505.

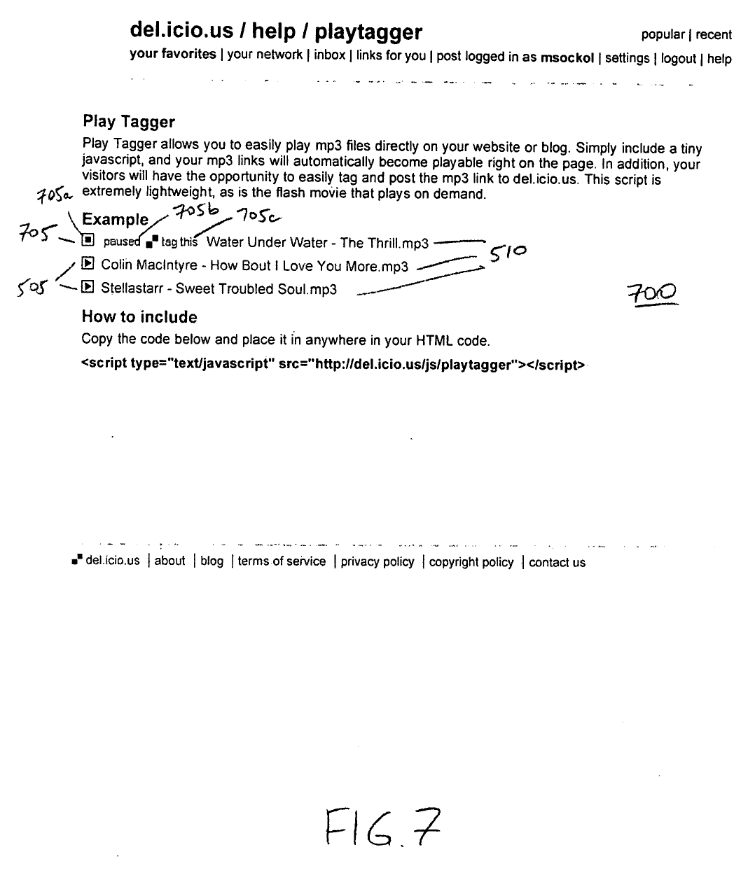

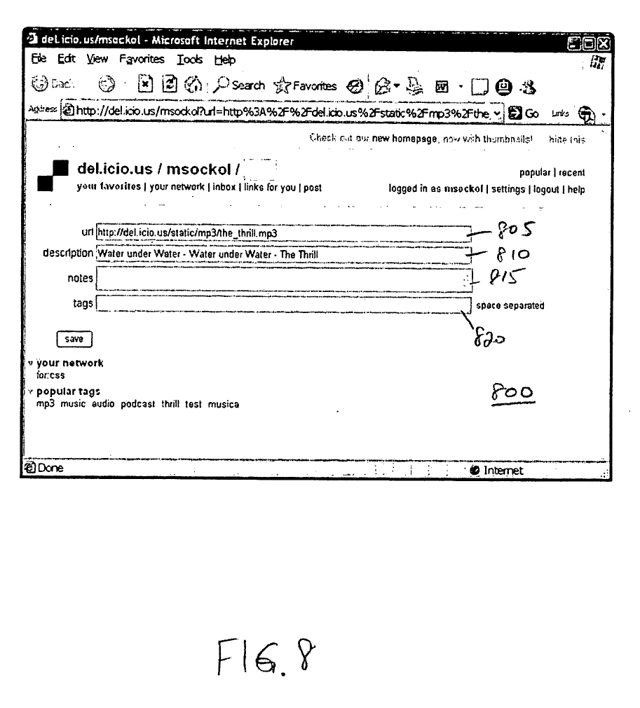

FIG. 6 illustrates an example user interface 600 with three MP3 file links 510, two playback icons 605 and one stop/pause/tag icon set 610, in accordance with an embodiment of the present invention. After clicking on the first playback icon 505 associated with “Water Under Water,” the playtagger script 155 causes the playback icon 505 to be replaced with a stop/pause/tag icon set 605. Playback icons 505 for the two remaining MP3 file links 510 remain unchanged. Stop/pause/tag icon set 605 includes a stop square 605a, such that clicking on the stop square 605a will cause the playtagger script 155 and Flash handler 160 to stop playback of the associated MP3 file 145. Stop/pause/tag icon set 605 also includes a pause icon 605b labeled as “playing,” such that clicking on the pause icon 605b will cause the playtagger script 155 and Flash handler 160 to pause playback of the associated MP3 file 145. FIG. 7 illustrates the user interface 600 after clicking the pause icon 605b. The stop/pause/tag icon set 605 also includes a tag icon 605c labeled as “tag this,” such that clicking on the tag icon 605c launches the browser 120 to open a new window to enable tagging the MP3 file link as a tagged bookmark at the Del.icio.us website. FIG. 8 illustrates the new window presented after clicking the tag icon 605c.

FIG. 7 illustrates an example user interface 700 with three MP3 file links 510, two playback icons 605 and one stop/resume/tag icon set 705, in accordance with an embodiment of the present invention. After clicking on the pause icon 605b, the playtagger script 155 causes the stop/pause/tag icon set 605 to be replaced by a stop/resume/tag icon set 705. The remaining playback icons 505 also remain unchanged. The stop icon 605a and tag icon 605c of the stop/resume/tag icon set 705 also appear unchanged from the stop icon 705a and tag icon 705c of the stop/pause/tag icon set 605. Specifically, the playtagger script 155 causes the pause icon 605b to be replaced with a resume icon 705b. The resume icon 705b of the stop/resume/tag icon set 705 is labeled as “paused.” Clicking on the resume icon 705b causes the playtagger script 155 and the Flash handler 160 to restart playback of the associated MP3 file 145 from the point at which it was paused.

FIG. 8 illustrates an example user interface 800 for tagging an MP3 file link 510 at the Del.icio.us website, in accordance with an embodiment of the present invention. After clicking on the tag icon 605c or 705c, the browser 120 automatically generates user interface 800. The user interface 800 includes a bookmark tagging form requesting the URL 805, a description 810, notes 815 and tags 820. The URL 805 is automatically populated with the MP3 file link 510. The description 810 is automatically populated with the title of the MP3 file 145.

Although the above user interfaces have been described with reference to audio MP3 files, one skilled in the art will recognize that embodiments of the invention can operate with audio, video and/or multimedia MP3 files. Further, although the above embodiments have been described with reference to MP3 file types, one skilled in the art will recognize that embodiments of the invention can operate with other audio, video and/or multimedia file types.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A system, comprising:
web page data including an MP3 file link to an MP3 file;
a playtagger script for generating a playback icon next to the MP3 file link; and
a Flash handler for configuring a Flash plugin to playback the MP3 file in response to activation of the playback icon.

2. The system of claim 1, wherein the playtagger script includes JavaScript.

3. The system of claim 1, wherein the playtagger script is located on one or more websites available to a browser, and the web page data includes a playtagger reference for enabling the browser to fetch the playtagger script.

4. The system of claim 1, wherein the playtagger script is fuirther operative to replace the playback icon with at least a stop icon, in response to the activation.

5. The system of claim 4, wherein the Flash handler is further operative to cause the Flash plugin to stop the playback in response to a stop request.

6. The system of claim 1, wherein the playtagger script is further operative to replace the playback icon with a stop/pause/tag icon set, in response to the activation.

7. The system of claim 6, wherein the Flash handler is further operative to cause the Flash plugin to stop the playback in response to a stop request and to pause the playback in response to a pause request.

8. The system of claim 1, wherein the Flash handler is located on one or more websites connected to a browser, and the playtagger script includes a Flash handler function caller for enabling the browser to fetch the Flash handler.

9. The system of claim 1, wherein the MP3 file includes audio.

10. The system of claim 1, wherein the MP3 file includes video.

11. A method, comprising:
using a browser to navigate to a web address;
downloading from the web address web page data including an MP3 file link to an MP3 file;
downloading a playtagger script;
using the playtagger script to generate a playback icon next to the MP3 file link;
downloading a Flash handler; and
using the Flash handler to configure a Flash plugin to playback the MP3 file in response to activation of the playback icon.

12. The method of claim 11, wherein the playtagger script includes JavaScript.

13. The method of claim 11, wherein the playtagger script is maintained on one or more websites available to the browser, and the web page data includes a playtagger reference for enabling the browser to download the playtagger script.

14. The method of claim 11, further comprising using the playtagger script to replace the playback icon with at least a stop icon, in response to the activation.

15. The method of claim 14, further comprising using the Flash handler to cause the Flash plugin to stop the playback in response to a stop request.

16. The method of claim 11, further comprising using the playtagger script to replace the playback icon with a stop/pause/tag icon set, in response to the activation.

17. The method of claim 16, further comprising using the Flash handler to cause the Flash plugin to stop the playback in response to a stop request and to pause the playback in response to a pause request.

18. The method of claim 11, wherein the Flash handler is located on one or more websites connected to the browser, and the playtagger script includes a Flash handler function caller for enabling the browser to download the Flash handler.

19. The method of claim 11, wherein the MP3 file includes audio.

20. The method of claim 11, wherein the MP3 file includes video.

21. A system, comprising:
means for navigating to a web address;
means for downloading from the web address web page data including an MP3 file link to an MP3 file;
scripting means for generating a playback icon next to the MP3 file link; and
Flash handler means for configuring a Flash plugin to playback the MP3 file in response to activation of the playback icon.
